(19) United States
(12) Patent Application Publication
(10) Pub. No.: US 2011/0302603 A1
(43) Pub. Date: Dec. 8, 2011

(54) CONTENT OUTPUT SYSTEM, CONTENT OUTPUT METHOD, PROGRAM, TERMINAL DEVICE, AND OUTPUT DEVICE

(75) Inventor: Hiroyuki Sugai, Chiba (JP)

(73) Assignee: SONY CORPORATION, Tokyo (JP)

(21) Appl. No.: 13/115,179

(22) Filed: May 25, 2011

(30) Foreign Application Priority Data
Jun. 2, 2010 (JP) P2010-126594

(51) Int. Cl. H04N 5/445

(52) U.S. Cl. 725/38

(57) ABSTRACT

A content output system has a terminal device which includes an input unit accepting an input of a selection of content performed by a user, a determination unit determining whether the content selected in accordance with the input to the input unit performed by the user is predetermined content, and a content-information transmission unit transmitting content information which is information on the content to an output device when the determination unit determines that the content is the predetermined content, and the output device which includes a content-information reception unit receiving the content information transmitted from the content-information transmission unit, a content-reception unit receiving the content corresponding to the content information, and an output unit outputting the content received by the content-reception unit.

### CROSS-REFERENCE TO RELATED APPLICATION

The present application claims priority from Japanese Patent Application No. JP 2010-126594 filed in the Japanese Patent Office on Jun. 2, 2010, the entire content of which is incorporated herein by reference.

### BACKGROUND

The present disclosure relates to content output systems, content output methods, programs, terminal devices, and output devices. Specifically, the present disclosure relates to a content output system, a content output method, a program, a terminal device, and an output device which are capable of facilitating searching of content on the Internet and outputting high-quality content.

In general, most television receivers include a function of connecting to a network, that is, a web (World Wide Web) browser function, capable of viewing web sites through the Internet. Furthermore, such a television receiver includes a decoding function such as an MPEG (Moving Picture Experts Group) and is capable of independently reproducing video content included in so-called video-sharing sites and video-delivery sites. Since such a television receiver reproduces video content delivered through the Internet, exciting moving images are reproduced with higher image quality and higher sound quality than moving images reproduced by displays of personal computers.

Note that specified users or unspecified users may upload video content on the video-sharing sites and view the video content updated on the video-sharing sites. Moving images posted on the video-sharing sites are generally reproduced as streaming using Flash Player (registered trademark) produced by Adobe Systems Incorporated. The streaming is a method for reproducing content while data of the content is received.

In order to reproduce video content provided through the Internet in a television receiver, a user should operate a remote controller of the television receiver so as to input a search word used for searching the video-sharing site for the video content, select the video content, and instruct start of the reproduction.

However, most general remote controllers of television receivers are not suitable for an operation of searching a video-sharing site for video content and selecting the video content. Furthermore, a screen for searching a video-sharing site for video content and a screen for displaying thumbnails are configured taking a case where a personal computer is used into consideration. Therefore, many steps are necessary to search for video content and select the video content using a remote controller, and this interferes with widespread viewing of web video content using a television receiver.

Here, a general personal computer normally includes input devices, such as a QWERTY keyboard and a mouse, suitable for an input operation. Therefore, use of the input devices facilitates high-speed search and high-speed selection of video content. However, in general, a display included in the personal computer is smaller than the television receiver in size. Furthermore, a speaker included in the personal computer is not excellent in terms of sound. Accordingly, the personal computer has disadvantages in reproduction of web video content when compared with the television receiver in terms of image quality, sound quality, and a screen size.

Accordingly, a technique of transmitting image data from a personal computer to a display device connected to the personal computer in a wired manner and displaying a video image corresponding to the image data output from the personal computer in the display device has been proposed (refer to Japanese Unexamined Patent Application Publication No. 2009-10629).

### SUMMARY

A technique of transmitting a video image output from a personal computer to a television receiver, such as the technique disclosed in Japanese Unexamined Patent Application Publication No. 2009-10629, is referred to as a so-called “PC-TV converter” which enables content provided through the Internet to be viewed using a television receiver. However, there arises a problem in that, since video data and audio data included in the content is transmitted and received by the PC-TV converter, an amount of data to be transmitted and received is increased, and therefore, the personal computer and the television receiver should perform a number of processes.

Accordingly, it is desirable to provide a content output system, a content output method, and a program which attain high operability and output of high-quality content by performing search and selection of content using a terminal device, such as a personal computer, having high operability, and by outputting the selected content using an output device, such as a television receiver, which realizes high image quality and high sound quality, and to provide the terminal device and the output device.

According to an embodiment of the present disclosure, there is provided a content output system which includes a terminal device having an input unit accepting an input of a selection of content performed by a user, a determination unit determining whether the content selected in accordance with the input to the input unit performed by the user is predetermined content, and a content-information transmission unit transmitting content information which is information on the content to an output device when the determination unit determines that the content is the predetermined content, and which includes the output device having a content-information reception unit receiving the content information transmitted from the content-information transmission unit, a content-reception unit receiving the content corresponding to the content information, and an output unit outputting the content received by the content-reception unit.

According to another embodiment of the present disclosure, there is provided a content output method of a content output system including a terminal device and an output device. The method includes accepting an input of a selection of content performed by a user, determining whether the content selected in accordance with the input performed by the user is predetermined content, and transmitting content information which is information on the content to the output device when it is determined that the content is the predetermined content, which are performed by the terminal device, and includes receiving the transmitted content information, receiving the content corresponding to the content information, and outputting the received content, which are performed by the output device.

According to still another embodiment of the present disclosure, there is provided a program which causes a terminal device to execute accepting an input of a selection of content performed by a user, determining whether the content selected in accordance with the input performed by the user is predetermined content, and transmitting content information which is information on the content to an output device when it is determined that the content is the predetermined content, and the output device to execute receiving the transmitted content information, receiving the content corresponding to the content information, and outputting the received content.

According to a further embodiment of the present disclosure, there is provided a terminal device including an input unit accepting an input of a selection of content performed by a user, a determination unit determining whether the content selected in accordance with the input to the input unit performed by the user is predetermined content, and a content-information transmission unit transmitting content information which is information on the content to an output device when the determination unit determines that the content is the predetermined content.

According to a still further embodiment of the present disclosure, there is provided an output device including a content-information reception unit receiving content information transmitted from a terminal device, a content-reception unit receiving content corresponding to the content information, and an output unit outputting the content received by the content-reception unit.

According to the present disclosure, search and selection of content are performed by a terminal device having high operability such as a personal computer and the selected content is output from an output device which realizes high image equality and high sound quality such as a television receiver, and accordingly, the high operability and output of high-quality content are simultaneously realized with ease in a simple manner.

### BRIEF DESCRIPTION OF THE DRAWINGS

FIG. 1 is a diagram schematically illustrating a configuration of a content output system;

FIG. 2 is a block diagram illustrating a configuration of a personal computer serving as a terminal device;

FIGS. 3A and 3B are diagrams illustrating display screens displayed in a display unit of the terminal device;

FIG. 4 is a diagram illustrating a configuration of a television receiver serving as an output device;

FIG. 5 is a sequence diagram illustrating a process performed by the content output system;

FIGS. 6A and 6B are diagrams illustrating a web browser displayed in the display unit of the terminal device; and

FIG. 7 is a diagram schematically illustrating a content output system according to a modification of the present disclosure.

### DETAILED DESCRIPTION OF EMBODIMENTS

Embodiments of the present disclosure will be described hereinafter with reference to the accompanying drawings. Note that description is made in the following order.

1. First Embodiment
1-1. Configuration of Content Output System
1-2. Configuration of Terminal Device
1-3. Configuration of Output Device
1-4. Operation of Content Output System

2. Modification

### 1. First Embodiment

### 1-1. Configuration of Content Output System

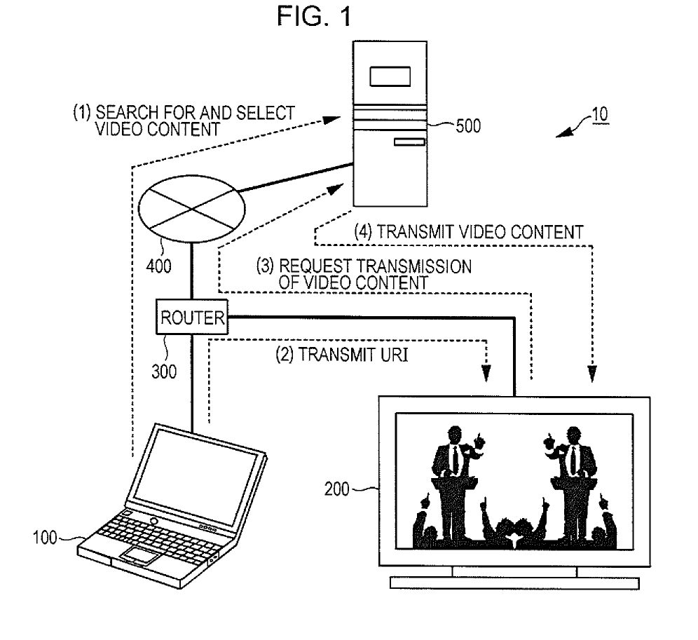

As shown in FIG. 1, a content output system 10 according to the present disclosure includes a personal computer 100 serving as a terminal device according to an embodiment and a television receiver 200 serving as an output device according to the embodiment. The personal computer 100 and the television receiver 200 are included in a LAN (Local Area Network) using a router 300 and are connected to a web server 500 through the Internet 400.

The router 300 having a relay function assigns an IP (Internet Protocol) address which conforms to a rule of the Internet to a device connected to the LAN so that the device connected to the network through the LAN may communicate with various external servers through the Internet 400. Furthermore, the router 300 performs a process of assigning a private IP address, for example, to the device connected to the LAN when the device connected to the LAN is not connected to the external Internet 400.

The web server 500 stores HTML (Hyper Text Markup Language) documents, image data, and various content such as video data and audio data which constitute a web site and the like. Furthermore, the web server 500 provides data and content in response to a request supplied from a web browser 109 of the personal computer 100 and a web browser 215 of the television receiver which will be described hereinafter.

The personal computer 100 and the television receiver 200 have respective web browsers and are connected to the Internet 400 through the router 300, and accordingly, enables viewing of web sites and reproduction of video content included in a video-sharing site. Here, the content includes web pages, video content, image content, music content, and text content. In this embodiment, a case where video content has been uploaded in the video-sharing side, the personal computer 100 performs search and selection of the video content, and the television receiver 200 reproduces the selected video content will be described as an example.

### 1-2. Configuration of Terminal Device

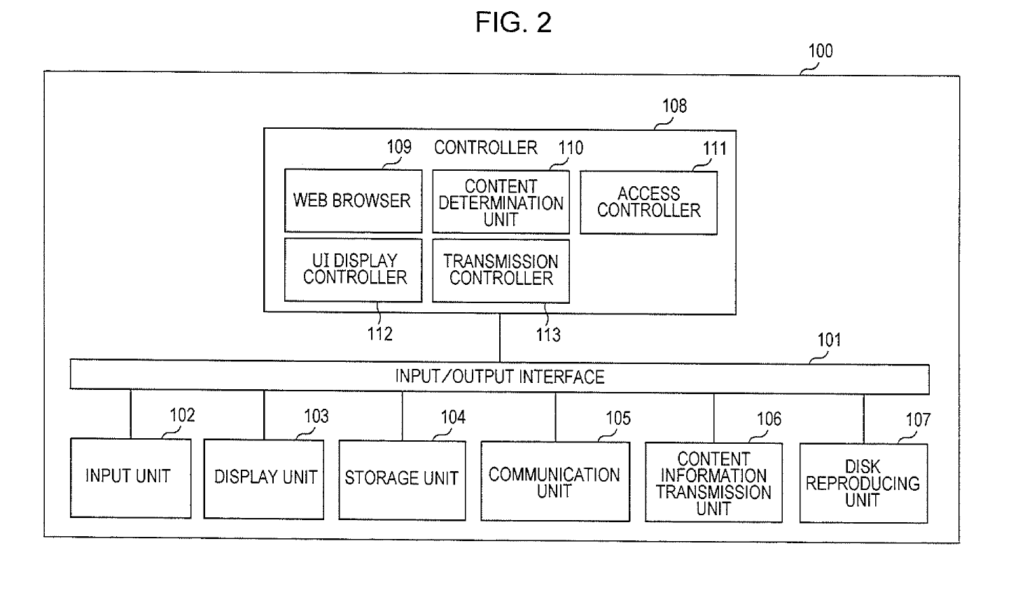

FIG. 2 is a block diagram schematically illustrating a configuration of the personal computer 100 which serves as a terminal device and which is included in the content output system 10. The personal computer 100 includes an input/output interface 101, an input unit 102, a display unit 103, a storage unit 104, a communication unit 105, a content information transmission unit 106, a disk reproducing unit 107, and a controller 108. The input unit 102, the display unit 103, the storage unit 104, the communication unit 105, the content information transmission unit 106, and the disk reproducing unit 107 are connected to the controller 108 through the input/output interface 101.

The input unit 102 includes input devices such as a keyboard, a mouse, a touch pad, and a touch panel which are used to input a word for searching for video content, to select the video content, and to input various instructions by the user. When an input is performed on the input unit 102, a control signal corresponding to the input is generated and output to the controller 108. The input unit 102 corresponds to an input unit according to an embodiment of the present disclosure.

The display unit 103 which is a display device such as an LCD (Liquid Crystal Display), a CRT (Cathode Ray Tube display), an organic EL (Electroluminescence) display displays a web site for the user. The storage unit 104 which is a high-capacity storage medium such as a hard disk stores various data and programs which are used to operate the personal computer 100, content obtained through the Internet 400, and temporary files.

The communication unit 105 includes an interface, a modem, and a terminal adapter used to communicate with the Internet 400 and the television receiver 200 serving as an output device in accordance with a predetermined protocol such as TCP/IP (Transmission Control Protocol/Internet Protocol).

Through the communication unit 105, various data is transmitted and received and streams of video content are downloaded.

The content information transmission unit 106 is an interface used to transmit content information to the television receiver 200 in accordance with a predetermined protocol such as TCP/IP similarly to the communication unit 105 under control of a transmission controller 113. Note that the communication unit 105 and the content information transmission unit 106 are separately described on the basis of functions thereof. However, the communication unit 105 and the content information transmission unit 106 may be configured as a single module. A wired communication or a wireless communication may be used as a communication method. However, when a wireless LAN (Local Area Network) is used for connection to the Internet 400 and used to configure the network, simple wiring is realized. Furthermore, the use of the wireless LAN enables the personal computer 100 and the television receiver 200 to be freely installed in any location. Note that, when the personal computer 100 and the television receiver 200 are connected to each other through a LAN, the personal computer 100 may directly transmit content information to the television receiver 200 without using the Internet 400.

The controller 108 includes a CPU (Central Processing Unit), a RAM (Random Access Memory), and a ROM (Read Only Memory). The ROM stores programs which are read and operated by the CPU. The RAM is used as a work memory of the CPU. The CPU controls entire operation of the personal computer 100 by executing various processes in accordance with the programs stored in the ROM and issuing commands. Furthermore, the controller 108 functions as the web browser 109, a content determination unit 110, an access controller 111, a UI (User Interface) display controller 112, and the transmission controller 113 by executing predetermined programs.

The web browser 109 is used to view web pages. Specifically, the web browser 109 accesses the web server 500 through the communication unit 105 and the Internet 400 so as to obtain information on a web page described by an HTML, an XHTML (Extensible Hyper Text Markup Language), or the like. Then, the web browser 109 analyzes content of the HTML or the XHTML, generates a web page having layout corresponding to a result of the analysis, and outputs the web page to the display unit 103. Then, the web page is finally displayed in the display unit 103 for the user.

Furthermore, the web browser 109 allows JavaScript (registered trademark), Adobe Flash Player (registered trademark), and the like to be operated. Video content included in the video-sharing site is not reproduced by video reproduction software activated separately from the web browser 109 but is reproduced using a plug-in for video reproduction, such as Adobe Flash Player, embedded in the web browser 109. Furthermore, video content included in a web page may be reproduced using QUICKTIME (registered trademark) provided by Apple Inc., Windows Media Player (registered trademark) provided by Microsoft Corporation, or the like. Examples of the web browser 109 include Firefox (registered trademark) provided by Mozilla Foundation, Chrome (registered trademark) provided by Google Inc., Safari (registered trademark) provided by Apple Inc., and the like.

The content determination unit 110 determines whether content selected by the user is video content. Specifically, the content determination unit 110 determines whether a web page to be accessed by the user using the web browser 109 is a page for reproduction of video content (hereinafter referred to as a “video reproduction page”), determines whether content requested by the user by clicking a link included in the web browser 109 is video content, and the like.

The content determination unit 110 performs the determination regarding content with reference to an URI (Uniform Resource Identifier) which represents a location of information resources on the Internet 400, for example. For example, when the video-sharing site corresponds to YouTube, a home page of YouTube is represented by a URI “http://www.youtube.com/”. Furthermore, a page which displays a result of searching for a moving image in YouTube is represented by a URI “http://www.youtube.com/results?search_query=******”. Moreover, a video reproduction page in YouTube is represented by a URI “http://www.youtube.com/watch?v=************”. The URI represents a location of video content on the Internet 400. Therefore, the content determination unit 110 refers to a URI of a page to be accessed by the user by performing a click on the web browser 109 or a URI of content selected by the user and determines whether the URI is “http://www.youtube.com/watch?v=************” representing the video content to thereby determine the content is video content. Note that the foregoing description is merely an example in the case of YouTube, and in other video-sharing sites such as a Niko-Niko Doga, the determination is made in accordance with URIs representing video content included in the respective video-sharing sites. Note that the URI includes a URL (Uniform Resource Locator) and a URN (Uniform Resource Name).

The content determination unit 110 makes the determination when the user clicks a link of a site, a page, or content on the Internet using the input unit 102. Note that the determination may be made not only in accordance with the URI but also with reference to a source code. Alternatively, the determination may be made using any other information as long as the information is used for the determination as to whether the content is video content. For example, the determination regarding content may be made in accordance with a determination as to whether the URI of the link clicked by the user includes an identifier, such as MP4 or WMV, representing a video file.

When it is determined that the content selected by the user is video content or it is determined that the page selected by the user is a video reproduction page, the access controller 111 performs control such that connection from the web browser 109 to the web server 500 is trapped (that is, access is restricted). Specifically, by restricting access from the web browser 109 to the video reproduction page, the video content is prevented from being reproduced by the personal computer 100.

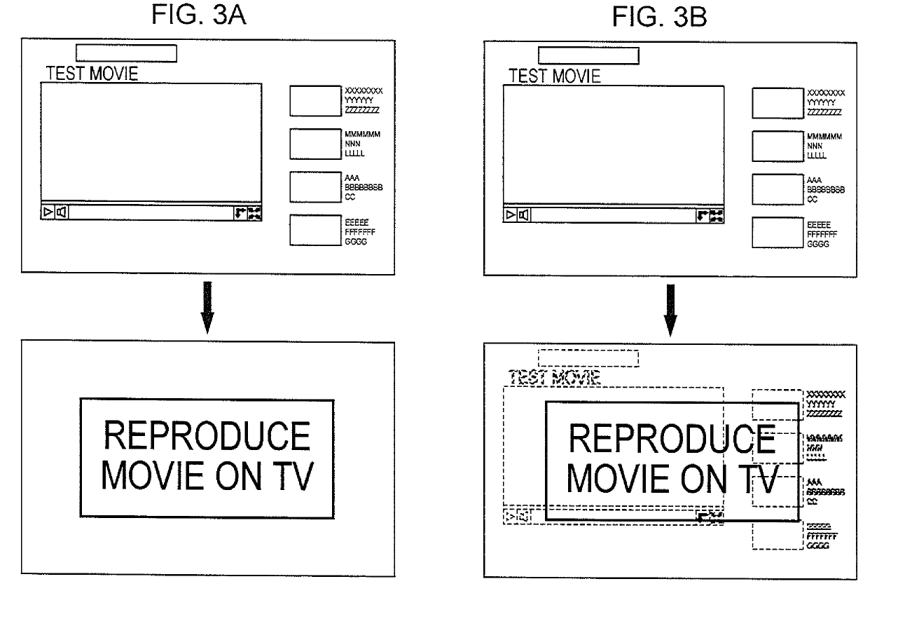

When it is determined that the page to be accessed by the user is a video reproduction page or it is determined that the content selected by the user is video content, the UI display controller 112 instructs the display unit 103 to display a predetermined UI. Here, the predetermined UI corresponds to a message or an icon shown as “reproduce movie on TV” in FIG. 3 which represents that the video content is not output from the personal computer 100 but output from the television receiver 200 for the user.

The UI may be displayed by changing an image of a web page which is currently displayed to the UI as shown in FIG. 3A or may be displayed such that the UI is superposed on the web page which is currently displayed as shown in FIG. 3B. Note that the display “reproduce movie on TV” is merely an example, and any display may be performed as long as the display notifies the user of information representing that moving images are reproduced on TV. The UI may disappear after a predetermined period of time (for example, several seconds).

When the content determination unit 110 determines that the content selected by the user corresponds to video content, the transmission controller 113 performs control such that information on the content is transmitted to the television receiver 200 through the content information transmission unit 106. In this embodiment, the content information corresponds to a URI of a page which displays the video content included in the video-sharing site. Accordingly, when YouTube is a video-content provision site, a URI “http://www.youtube.com/watch?v=************” representing a video reproduction page is supplied to the television receiver 200 from the content information transmission unit 106 as the content information. Furthermore, the transmission controller 113 transmits a certain control signal to the television receiver 200 through the content information transmission unit 106 so that a normal mode for television broadcasting (hereinafter referred to as a “normal TV mode”) is changed to a mode for reproduction of video content (hereinafter referred to as a “web video reproduction mode”).

Note that the content determination unit 110, the access controller 111, the UI display controller 112, and the transmission controller 113 are separately configured on the basis of functions thereof. However, they may be configured and provided as add-ons or plug-ins which expand functions of the web browser 109 by being installed in the personal computer 100 by the user in practice.

The personal computer 100 is an example of the terminal device according to the embodiment, and the terminal device is not limited to a personal computer. Any terminal device may be used as long as the terminal device is capable of being connected to the Internet, viewing web pages, searching for content on the Internet, and reproducing the content. Other examples of the terminal device include a cellular phone, a smartphone, and a portable game machine.

### 1-3. Configuration of Output Device

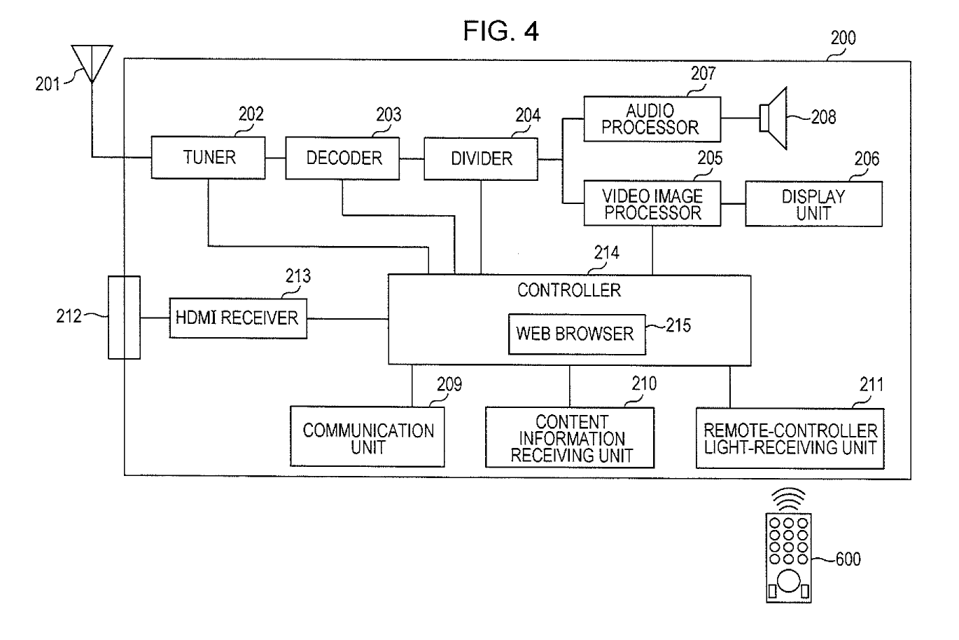

FIG. 4 is a diagram illustrating a configuration of the television receiver 200 which serves as an output device and which is included in the content output system 10. The television receiver 200 enables analog broadcasting, digital terrestrial broadcasting, BS (Broadcasting Satellite) Broadcasting, CS (Communications Satellite) broadcasting, and so on to be viewed and includes an Internet connection function which enables web sites and video content to be viewed. The television receiver 200 includes an antenna 201, a tuner 202, a decoder 203, divider 204, a video image processor 205, a display unit 206, an audio processor 207, a speaker 208, a communication unit 209, a content information receiving unit 210, a remote-controller light-receiving unit 211, an HDMI (High Definition Multimedia Interface) terminal 212, an HDMI receiver 213, and a controller 214.

The antenna 201 receives various broadcasting waves of digital terrestrial broadcasting and the like and supplies signals of the broadcasting waves to the tuner 202. The tuner 202 converts a broadcasting wave signal supplied from the antenna 201 into an intermediate frequency signal to be output to the decoder 203. The decoder 203 decodes the intermediate frequency signal so as to extract a transport stream which is a video stream from the intermediate frequency signal and supplies the transport stream to the divider 204. The divider 204 includes a demultiplexer which separates the transport stream and a decoder which performs decoding. The divider 204 divides the transport stream into a video PES (Packetized Elementary Stream), an audio PES, and the like according to a packet identifier (PID). Then, the divider 204 performs predetermined signal processing on the video PES and the audio PES obtained through the division so as to convert the video PES and the audio PES into a video signal and an audio signal. The audio signal is output to the audio processor 207 and the video signal is output to the video image processor 205.

The audio processor 207 performs a predetermined process such as an amplification process on the audio signal and outputs the audio signal to the speaker 208. The speaker 208 is an audio output unit which outputs the audio signal supplied from the audio processor 207 as audio for a user. The video image processor 205 performs a predetermined process on the video signal and outputs the video signal to the display unit 206. The display unit 206 corresponding to an LCD, CRT, an organic EL display, or the like displays a video image corresponding to the video signal supplied from the video image processor 205. The display unit 206 and/or the speaker 208 corresponds to an output unit according to an embodiment of the present disclosure.

The communication unit 209 corresponds to an interface, a modem, a terminal adapter, or the like used to communicate with the Internet 400 and the personal computer 100 in accordance with a predetermined protocol such as TCP/IP. Through the communication unit 209, transmission/reception of various data, download of streams of video content, and the like are performed. The communication unit 209 corresponds to a content reception unit according to an embodiment of the present disclosure.

The content information receiving unit 210 is an interface used to receive content information supplied from the content information transmission unit 106 included in the personal computer 100 in accordance with, similarly to the communication unit 209, a predetermined protocol such as TCP/IP. Note that, although the communication unit 209 and the content information receiving unit 210 are separately described on the basis of functions thereof, they may be configured as a single module.

The remote-controller light-receiving unit 211 receives a control signal supplied, in response to a user's operation, from a remote controller 600 associated with the television receiver 200 and outputs the control signal to the controller 214.

The controller 214 includes a CPU, a RAM, and a ROM. The ROM stores programs which are read and operated by the CPU. The RAM is used as a work memory of the CPU. The CPU controls entire operation of the television receiver 200 by executing various processes in accordance with the programs stored in the ROM and issuing commands. Furthermore, the controller 214 functions as the web browser 215 by executing a predetermined program.

The web browser 215 is used to view web pages. The web browser 215 accesses the web server 500 through the communication unit 209 and the Internet 400 so as to obtain information on a web page described by HTML or the like. Then, the web browser 215 analyzes content of the HTML so as to generate a web page having layout corresponding to a result of the analysis and outputs the generated web page to the video image processor 205. Thereafter, the web page is subjected to a predetermined process by the video image processor 205 and output to the display unit 206. Finally, the web page is displayed in the display unit 206 for the user. Moreover, JavaScript, Adobe Flash Player, and the like may be operated on the web browser 215. Video content included in the video-sharing site is not reproduced by video reproduction software which is activated separately from the web browser 215 but is reproduced by a plug-in for video reproduction embedded in the web browser 215 such as Adobe Flash Player.

Furthermore, the controller 214 decodes the control signal output from the remote-controller light-receiving unit 211 and outputs another control signal corresponding to the decoded control signal to the various units included in the television receiver 200. By this, the television receiver 200 is controlled so as to perform an operation in response to a user's instruction (channel selection, volume control, or the like).

The HDMI terminal 212 is an external input terminal which conforms to an HDMI standard. By using an HDMI cable, the television receiver 200 may be connected to another device having an HDMI output function. The HDMI receiver 213 which is a module having an HDMI reception function receives a TMDS (Transition Minimized Differential Signaling) signal supplied from the HDMI terminal 212, extracts a video signal, an audio signal, and a control signal included in the TMDS signal, restores these signals, and outputs the signals.

Note that the television receiver 200 is an example of an output device according to the embodiment, and the output device is not limited to the television receiver. Any output device may be used as long as the output device enables viewing of web pages and reproduction of video content on the Internet. Examples of the output device include a personal computer, a cellular phone, a smartphone, and a portable game machine.

### 1-4. Operation of Content Output System

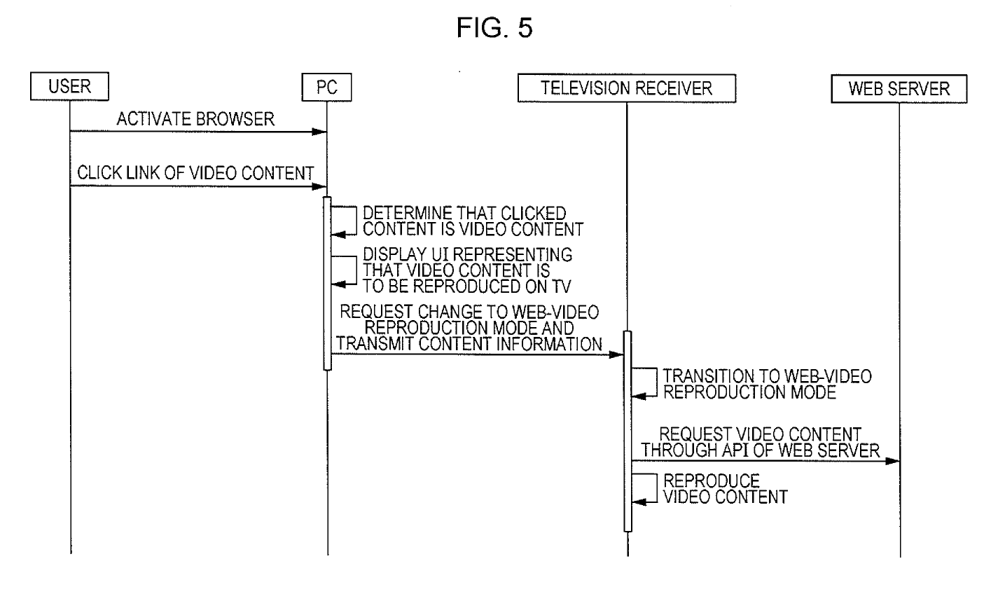

The content output system 10 is configured as described above. Next, a process performed by the content output system 10 will be described with reference to FIG. 1 which schematically illustrates the configuration of the content output system 10 and FIG. 5 which is a sequence diagram.

Note that before the process described below is performed by the content output system 10, first, the user sets the personal computer 100 and the television receiver 200 in advance such that one of the personal computer 100 and the television receiver 200 is an object of transmission/reception for the other. This setting is so-called “pairing”. The pairing is set, for example, by exchanging an ID (identification information) of the personal computer 100 and an ID of the television receiver 200 between the personal computer 100 and the television receiver 200 through the communication unit 105 and the communication unit 209. The IDs are addresses used to individually specify the personal computer 100 and the television receiver 200. Examples of the IDs include an ID assigned when an electronic device is fabricated such as a MAC (Message Authentication Code) address and an IP address which is an identification number assigned to a device connected to a network.

Furthermore, an operation of the personal computer 100 in the process of the content output system 10 is performed in a mode in which the personal computer 100 transmits content information to the television receiver 200 without reproducing video content (hereinafter referred to as a “content-information transmission mode”). In other words, in the content-information transmission mode, the content determination unit 110, the access controller 111, the UI display controller 112, and the transmission controller 113 operate.

The user may arbitrarily switch a mode in which video content is reproduced by the personal computer 100 (hereinafter referred to as a “normal PC mode”) to the content-information transmission mode and vice versa. By this, the user may select viewing of video content using the personal computer 100 or viewing of video content using the television receiver 200.

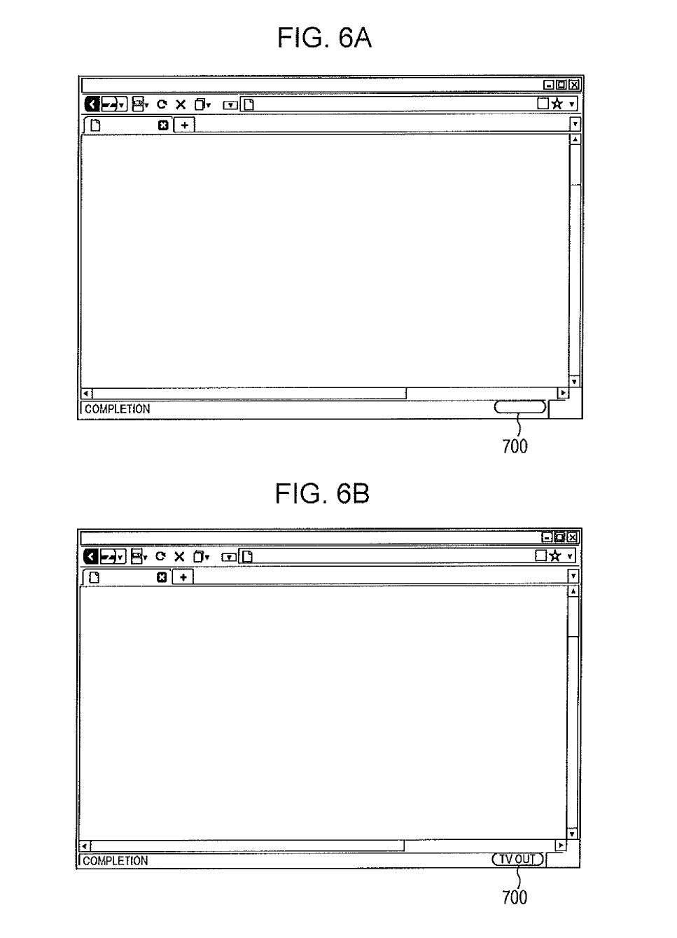

The switching between the normal PC mode and the content-information transmission mode may be performed, for example, by clicking a mode switching button 700 disposed in the web browser 109 as shown in FIGS. 6A and 6B. In FIG. 6A, the mode switching button 700 is shaded, that is, the personal computer 100 operates in the normal PC mode. When the mode switching button 700 is clicked, the mode switching button 700 is clearly displayed as shown in FIG. 6B, that is, the personal computer 100 enters the content-information transmission mode. The mode switching function using the mode switching button 700 may be provided simultaneously when the controller 108 provides with a function of the content determination unit 110 by installing a plug-in.

Hereinafter, the process performed by the content output system 10 will be described. First, the user performs a predetermined input operation through the input unit 102 of the personal computer 100 so that the web browser 109 is activated. Then, the user accesses a web site, video-sharing site, or the like so as to search the site for content and clicks a link of video content so as to select the video content to be reproduced (represented by (1) of FIG. 1).

Then, the content determination unit 110 determines whether the content to be accessed by the user is video content. The determination is performed with reference to a URI of the content as described above. When it is determined that the content is video content, the access controller 111 restricts access from the web browser 109 to the video content. By this, the video content is not reproduced by the personal computer 100. Subsequently, the UI display controller 112 displays a message representing that a video image is to be reproduced on the television receiver 200 in the display unit 103 of the personal computer 100 as shown in FIG. 3.

Next, under control of the transmission controller 113, the URI of the video content to be accessed by the user which is content information is transmitted to the television receiver 200 through the content information transmission unit 106 (represented by (2) of FIG. 1). Simultaneously, a mode switching signal representing switching of a mode from the normal TV mode to a web-video reproduction mode is supplied to the television receiver 200. After transmitting the content information, the personal computer 100 may perform another operation such as an operation of searching for another video image, an operation of viewing another web page, an operation of activating an application, or the like. Accordingly, the message representing that the reproduction of the video image is performed by the television receiver 200 may disappear after a predetermined period of time.

Next, when receiving the content information and the mode switching signal supplied from the personal computer 100 using the content information receiving unit 210, the television receiver 200 automatically enters the web video reproduction mode. Note that the content information and the mode switching signal may be directly transmitted from the personal computer 100 to the television receiver 200 without using the Internet 400 when the LAN is configured using the personal computer 100 and the television receiver 200 as shown in FIG. 1.

In the present disclosure, transmission/reception of video data and audio data having large volumes is not performed between the personal computer 100 and the television receiver 200 but only transmission/reception of the URI and the mode switching signal is performed, and therefore, a transmission amount is suppressed and the number of processes to be performed for the transmission/reception is reduced.

Consequently, the content output system may be configured using a personal computer and a television receiver which have small memory capacities and low CPU performances, that is, a so-called low-spec personal computer and a so-called low-spec television receiver.

The television receiver 200 activates the web browser 215 after entering the web-video reproduction mode. Then, the television receiver 200 accesses the web server 500 using the web browser 215 in accordance with the URI serving as the content information supplied from the personal computer 100. Then, the television receiver 200 requests the web server 500 to transmit the video content (start of delivery of the video content) (represented by (3) of FIG. 1).

The web server 500 which received the content delivery start request transmits the video content to the television receiver 200 through the Internet 400 (represented by (4) of FIG. 1). Then, the television receiver 200 displays the video content in the display unit 206 and starts reproducing streaming of the video content. Note that the reproduction of the video content may be performed as a so-called full-display. The reproduction in the full-display takes advantage of television receivers which have screen sizes generally larger than those of personal computers.

After start of the reproduction of the video content using the television receiver 200, fast-forward, fast-rewind, pause, and the like of the video content may be instructed using the remote controller 600 associated with the television receiver 200. Furthermore, a button (input unit) used to input an instruction for switching from the web video reproduction mode to the normal TV mode may be disposed on the remote controller 600 associated with the television receiver 200. By this, the switching from the web video reproduction mode to the normal TV mode may be performed in any time, for example, while the video content is reproduced or after the reproduction of the video content is terminated.

Moreover, the content information transmission mode may be entered so that the content information is transmitted to the television receiver 200 also when the mode switching button 700 is clicked while the video content is reproduced in the personal computer 100 operating in the normal PC mode. In this case, when the normal PC mode is switched to the content information transmission mode by clicking the mode switching button 700, a URI of the video content which is being reproduced at this time is referred to, the URI of the video content is transmitted as described above, access control is performed, and a UI is displayed. By this, even while the video content is being reproduced in the personal computer 100, the video content may be reproduced by the television receiver 200 without clicking the link of the video content again.

As described above, the user may perform search and selection of video content using the personal computer 100 which includes a keyboard and a mouse which attain high operability and reproduce the video content using the television receiver 200. Accordingly, the search and the like of video content are easily performed at high speed and the video content is viewed in a large screen with high image quality and high sound quality. According to the present disclosure, the personal computer 100 having the high operability and the television receiver 200 capable of outputting content with high quality work together making use of the advantages of the personal computer 100 and the television receiver 200. Consequently, the television receiver 200 reproduces video content with ease, and therefore, opportunity of reproduction of video content posted on web sites is increased and a value of the video content itself is enhanced.

Furthermore, in the present disclosure, a device to receive content is changed from a terminal device to an output device after the content is selected. Therefore, when a communication speed of the output device is higher than that of the terminal device, video content is downloaded at higher speed, and accordingly, the video content is viewed in a stress-free manner. Examples of such a case include a case where the terminal device corresponds to a smartphone which performs communication in a 3G (third-generation cellular phone) method and the output device corresponds to a television receiver capable of being connected to the Internet through an optical fiber or the like.

### 2. Modification

The embodiment of the present disclosure has been described in detail hereinabove. However, the present disclosure is not limited to the foregoing embodiment and various modifications may be made within the scope of the disclosure. In the foregoing embodiment, the case where content corresponds to video content included in a video-sharing site is taken as an example. However, the content is not limited to video content. The content may be a web page, image content, music content, or text content. When the content is an image on the Internet, for example, a URI of the content includes an extension which represents an image, i.e., “http://**********.jpg” or “http://**********.gif”, and therefore, the content determination unit 110 may discriminate a type of the content with reference to the extension representing the image included in the URI.

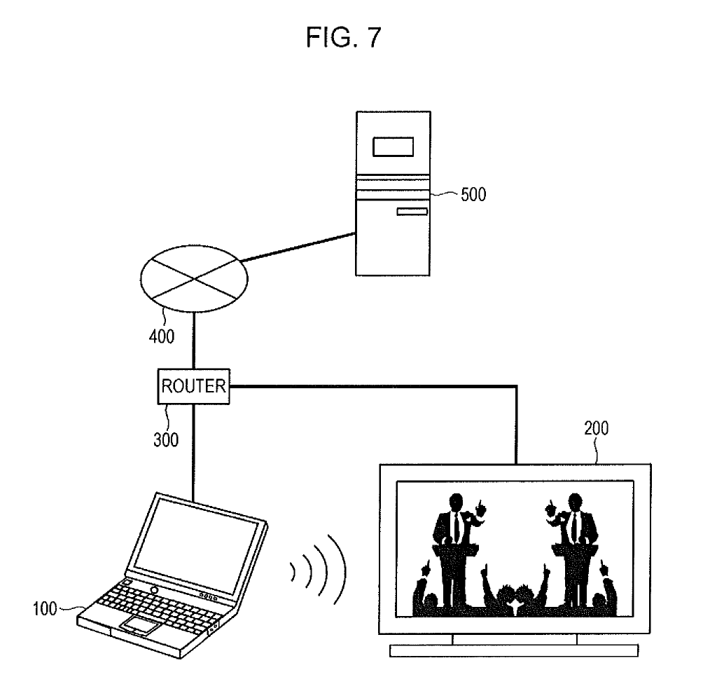

Furthermore, in the foregoing embodiment, the case where the terminal device and the output device are connected to each other using a wireless LAN has been described as an example. However, the connection method between the terminal device and the output device is not limited to the wireless LAN. For example, Bluetooth (registered trademark) or ZigBee (registered trademark) may be used for the connection as shown in FIG. 7. Furthermore, an infrared communication may be used.

Moreover, in the foregoing embodiment, the case where search of video content is performed using the personal computer 100 serving as the terminal device and reproduction of the video content is performed using the television receiver 200 has been described as an example. However, the present disclosure is not limited to such a case. For example, search of video content is performed using the personal computer 100 and a URI of the content is transmitted to a mobile terminal such as a smartphone or a portable game machine which is connectable to the Internet 400. Then, the video content may be viewed using the mobile terminal in a location different from a location where the personal computer 100 has been installed. Furthermore, a URI of music content on the Internet may be transmitted to an audio system connected to the Internet so that music corresponding to the music content may be listened with high sound quality.

It should be understood by those skilled in the art that various modifications, combinations, sub-combinations and alterations may occur depending on design requirements and other factors insofar as they are within the scope of the appended claims or the equivalents thereof.

What is claimed is:

1. A content output system comprising:
a terminal device including
an input unit accepting an input of a selection of content performed by a user,
a determination unit determining whether the content selected in accordance with the input to the input unit performed by the user is predetermined content, and
a content-information transmission unit transmitting content information which is information on the content to an output device when the determination unit determines that the content is the predetermined content; and
the output device including
a content-information reception unit receiving the content information transmitted from the content-information transmission unit,
a content-reception unit receiving the content corresponding to the content information, and
an output unit outputting the content received by the content-reception unit.

2. The content output system according to claim 1,
wherein the content is stored in a server on the Internet and the content information corresponds to a URI representing a location of the content on the Internet.

3. The content output system according to claim 2,
wherein the determination unit determines whether the content selected by the user is the predetermined content with reference to the URI.

4. The content output system according to claim 1,
wherein the predetermined content is video content.

5. The content output system according to claim 4,
wherein a personal computer serves as the terminal device and a television receiver serves as the output device.

6. The content output system according to claim 1,
wherein the input unit further accepts an input performed by the user corresponding to an instruction for transmitting the content information to the output device, and
the content-information transmission unit transmits the content information to the output device when the instruction for transmitting the content information to the output device is input.

7. The content output system according to claim 1,
wherein the terminal device further includes a display unit displaying information representing that the content is to be output from the output device when the determination unit determines that the content is the predetermined content.

8. A content output method of a content output system including a terminal device and an output device, the content output method comprising:
accepting an input of a selection of content performed by a user,
determining whether the content selected in accordance with the input performed by the user is predetermined content, and
transmitting content information which is information on the content to the output device when it is determined that the content is the predetermined content,
which are performed by the terminal device; and
receiving the transmitted content information,
receiving the content corresponding to the content information, and
outputting the received content,
which are performed by the output device.

9. A program which causes a terminal device to execute accepting an input of a selection of content performed by a user,
determining whether the content selected in accordance with the input performed by the user is predetermined content, and
transmitting content information which is information on the content to an output device when it is determined that the content is the predetermined content, and
the output device to execute
receiving the transmitted content information,
receiving the content corresponding to the content information, and
outputting the received content.

10. A terminal device comprising:
an input unit accepting an input of a selection of content performed by a user;
a determination unit determining whether the content selected in accordance with the input to the input unit performed by the user is predetermined content; and
a content-information transmission unit transmitting content information which is information on the content to an output device when the determination unit determines that the content is the predetermined content.

11. An output device comprising:
a content-information reception unit receiving content information transmitted from a terminal device;
a content-reception unit receiving content corresponding to the content information; and
an output unit outputting the content received by the content-reception unit.
